(19) United States
(12) Patent Application Publication
(10) Pub. No.: US 2025/0264150 A1
(43) Pub. Date: Aug. 21, 2025

(54) DRIVE SYSTEM

(71) Applicant: Jörg BEUTLER, Holzkirchen (DE)

(72) Inventor: Jörg BEUTLER, Holzkirchen (DE)

(21) Appl. No.: 19/053,033

(22) Filed: Feb. 13, 2025

(30) Foreign Application Priority Data
Feb. 21, 2024 (EP) 24158881.3

(51) Int. Cl. F16H 19/00; F16H 19/04; F16H 57/12

(52) U.S. Cl. CPC F16H 19/001; F16H 19/04; F16H 2019/008; F16H 2057/122

(57) ABSTRACT

Drive systems may include a drive element and a mating toothing. The drive element 2 has a first drive wheel and a second drive wheel, each of them having engagement elements. The engagement elements of the first drive wheel and the engagement elements of the second drive wheel engage the mating toothing alternately, and at least one engagement element of the first drive wheel and at least one engagement element of the second drive wheel are in engagement with the mating toothing at least for a period of time.

### FIELD

This disclosure relates to toothed gearing systems and methods. More specifically, the disclosed embodiments relate to drives for transport systems such as those relating to rollercoasters.

### INTRODUCTION

Form-fit drives are known, for example in transport systems, such as rack railways or in mining applications. Compared to frictional drives, form-fit drives have the advantage that efficiency may be improved, since sliding of the drive wheel on the drive rail is practically excluded. In addition, higher torques and thus greater accelerations may be transmitted from the drive to a mating toothing which may be, e.g., a rack or a toothed chain.

However, it may be a problem that, particularly when transmitting higher torques, a suitable transmission from the motor to the mating toothing may not be implemented and the power transmission may be limited by the number of simultaneously meshing teeth of the drive pinion. Furthermore, irregularities in the mating toothing, e.g. pitch errors in the mating toothing or transitions from one to the next mating toothing, may not be satisfactorily compensated for in certain applications.

This problem may be solved by increasing the diameter of the drive pinion, i.e. by increasing the pitch circle diameter of the drive pinion that engages with the mating toothing. However, this measure significantly increases the space required and results in a higher torque demand, which places greater demands on the gearbox. In addition, the individual engagement elements are not arranged in a displaceable manner relative to one another for design reasons, even with an enlarged drive wheel, which means that indexing errors within the mating toothing may cause the entire driving force to be transmitted by a single engagement element, at least temporarily, resulting in a possible overloading of individual engagement elements.

A form-fit drive known in the prior art is shown in patent no. EP2483121B1.

### SUMMARY

On this basis, the present disclosure proposes a drive system with reduced space requirements that may compensate for pitch errors in the mating toothing.

The drive system according to the present disclosure comprises: a drive element; and a mating toothing or gearing (e.g., a rack or a toothed chain), wherein the drive element has two or more drive wheels, including a first drive wheel and a second drive wheel, each of them having engagement elements (e.g. teeth), wherein the drive wheels are arranged such that engagement elements of the first drive wheel and the second drive wheel alternately engage in the mating toothing, and at least one engagement element of first drive wheel and of the second drive wheel is at least temporarily (e.g. while a vehicle comprising the drive element passes a certain section of a track comprising the counter toothing) and/or contemporaneously in engagement with the mating toothing.

The engagement elements of the drive wheels (e.g. first and second drive wheel) are each tangentially offset relative to one another. Being tangentially offset means being offset in a circumferential direction. That is to say, in a radial projection, the engagement elements of, for example, a first drive wheel, do not superimpose on the engagement elements of, for example, a second, third, etc., drive wheel during operation of the drive system, but are offset in the circumferential direction relative to the engagement elements of the other drive wheels. In particular, the drive wheels are designed to have the same configuration or at least to have the same radius. In some examples, the engagement elements of a drive wheel are arranged equidistantly around the circumference. In the lateral (radial) projection view of a plurality of drive wheels arranged one above the other, for example, the engagement elements of a first of the drive wheels are located between the engagement elements of the other drive wheels. In the case of two drive wheels arranged one above the other, the engagement elements of a first of the drive wheels are located between the engagement elements of a second of the drive wheels, in particular centrally between the engagement elements of the second drive wheel. However, during operation of the drive system, slight deviations in the tangential offset of the engagement elements of the various engagement wheels may be possible, since the motors assigned to the drive wheels compensate for irregularities or indexing errors in the mating toothing, in particular by controlling the torque of the motors.

Furthermore, the at least two drive wheels may be arranged axially offset and/or coaxially to one another. They may engage the same component of the mating toothing or different components of the mating toothing, e.g. the first drive wheel may engage a first mating-toothing component and the second drive wheel may engage a further mating-toothing component (which is stationary relative to the first mating toothing component).

In examples having a common motor for at least two drive wheels, compensation for irregularities or indexing errors may be achieved by a mechanical and/or hydraulic torque distribution, in particular by a differential gear.

As a result, at least two separate drive wheels may be arranged one above the other. They may be arranged parallel and coaxially next to each other. The drive wheels may be controlled separately. With two drive wheels, each drive wheel has only half of the engagement elements, with three drive wheels only a third, etc. The engagement elements of the drive wheels arranged one above the other or next to each other are, as described, arranged tangentially offset to each other, so that the engagement elements of the different drive wheels engage the mating toothing alternately or sequentially.

The drive system is a form-fitting drive system in which several engagement elements simultaneously engage a mating toothing. This means that the drive wheels are designed, for example, as gears/pinions that engage a mating toothing, for example a toothed rack, in a form-fitting manner and transmit a torque relative to the mating toothing.

The drive system according to the invention may be used in a variety of applications. For example, the mating toothing may be stationary, so that a vehicle provided with the drive wheels moves along the rack (translationally) by the transmission of the torque of the gear wheels to the rack. The vehicle may, for example, be a rail-bound vehicle, such as a transport and/or a rollercoaster vehicle that moves along a track. In other applications, the drive wheels may be arranged in a stationary manner and move an object connected to the mating toothing in a translational manner. The drive system then acts as a linear drive, which is designed in a manner analogous to a spindle drive or electric cylinder, and which may apply high forces to the mating toothing/rack. Further special applications may be realized, for example, in the field of machine tools or conveyor technology.

In an embodiment of the invention the drive system may have a common motor for at least two drive wheels, which drives the at least two drive wheels via a mechanical and/or hydraulic torque distribution.

The mechanical and/or hydraulic torque distribution may comprise at least one differential gear.

In another embodiment of the invention, the drive system may comprise at least two motors, each of which drives one of the drive wheels. The drive wheels are driven independently of each other. The position of the engagement elements of the second drive wheel, which are (in a radial projection) primarily regularly arranged alternately between or with a defined tangential offset relative to the engagement elements of the first drive wheel and/or other drive wheels, may vary with respect to the engagement elements of the first drive wheel and/or other drive wheels during operation, or the position of the engagement elements of the second drive wheel may be displaced relative to the engagement elements of the first drive wheel and/or other drive wheels during operation.

If there were more than two drive wheels, a corresponding number of motors may be provided, each of which may move a drive wheel independently of the others.

In some examples, the drive system may have at least two motors, each of which is controlled in such a way that they continuously apply a predetermined (constant) torque, at least during a particular period. A torque control may be used, for example, to compensate for irregularities or gaps in the toothing.

In some examples, the at least two motors are electric motors with torque control or torque regulation. Torque control/regulation allows precise control over the torque output. For example, a controller calculates the required control command based on an actual-setpoint comparison in order to adjust the torque of the motor to a setpoint. The control is often done by controlling the drive current. The controller may adjust the amplitude or phase of the current to achieve the desired torque.

The two or more drive wheels may be electrically controlled in such a way that a larger overlap of the tooth contact is simulated, which would otherwise only be achievable by using a larger pitch circle diameter. A larger overlap of the tooth contact is achieved by controlling the torque of the drive motors so that the engagement elements advance until there is tooth contact with the mating toothing in order to be able to apply torque to the contacted tooth of the mating toothing. As a result of this kind of control the distance between the engaging elements of the first drive wheel and the second drive wheel (and any further drive wheels) will vary slightly during operation, i.e. the tangential offset of the engagement elements varies and always adjusts so that at least one engagement element of each drive gear is always engaged with the mating toothing and may transfer a rate of the total drive torque to the mating toothing. The engagement elements rotate faster until they contact a tooth of the mating toothing and are stop. Therefore, it is possible to get several engagement elements to engage at the same time, despite smaller pitch circle diameters.

Systems and methods of the present disclosure achieve the following goals:
The total driving force (torque) generated by the motors may be reliably and evenly distributed across two or more engagement elements (particularly of different drive wheels). This means that the engagement elements and the mating toothing may be designed with smaller dimensions.
Redundancy is provided so that if a first drivetrain (having a first drive wheel) failed, at least one other (second) drivetrain (having a second drive wheel) would be available that could continue to provide locomotion with a rate of the total driving force (torque). The second drivetrain may be used for emergency running as well as for controlled motor braking.
Higher force/torque may be transmitted, while at the same time the space required is smaller than in conventional drive systems using a single drive wheel for direct power/torque transmission to the mating toothing.
The motors may be designed smaller and with lower power than in the case of a single, more powerful drive motor.

The at least two drive wheels may be arranged radially offset and/or axially offset to each other. In general, the drive wheels are arranged parallel to each other and engage the same or different mating toothing components.

The drive wheels may be arranged at a vehicle and the mating toothing may be arranged stationary at a transport track.

The mating toothing may comprise at least one rack or chain.

The engagement elements, in some examples, comprise cylinders, each having at least one rotatable element for rolling on the mating toothing.

In particular, at least one of the drive wheels may comprise engagement elements that are arranged so as to be radially displaceable towards the center of the drive wheel.

The engagement elements may be pushed radially outwards away from the center of the drive wheel by an elastic force, for example a spring force. In this way, the engagement elements precisely engage the mating toothing.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a perspective view of a drive system according to the present disclosure.

FIG. 2 is a schematic view of the arrangement of two drive wheels of a drive system according to the present disclosure.

FIG. 3 is a schematic view of a further aspect of the present disclosure.

### DETAILED DESCRIPTION

Various aspects and examples of a novel drive system, as well as related methods, are described below and illustrated in the associated drawings. Unless otherwise specified, a drive system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

“Coupled” means connected, either permanently or releasably, whether directly or indirectly through intervening components.

“Providing,” in the context of a method, may include receiving, obtaining, purchasing, manufacturing, generating, processing, preprocessing, and/or the like, such that the object or material provided is in a state and configuration for other steps to be carried out.

The following describes selected aspects of illustrative drive systems, as well as related systems and/or methods. The examples described are intended for illustration and should not be interpreted as limiting the scope of the present disclosure.

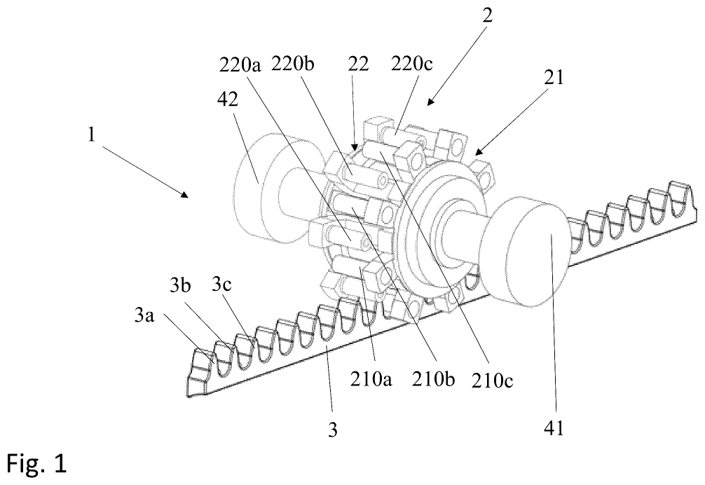

FIG. 1 shows a perspective view of a drive system 1 having a drive element 2 with two drive wheels 21, 22 and a mating toothing 3. The drive wheels 21, 22 each have a plurality of engagement elements (e.g. teeth, rotatable rollers) 210a, 210b, 210c, . . . ; 220a, 220b, 220c, . . . , of which only individual ones are designated in FIG. 1. The engagement elements 210a, 210b, 210c, . . . ; 220a, 220b, 220c, . . . , of each of the drive wheels 21,22 are arranged equidistantly to one another.

The mating toothing 3 also has engagement elements 3a, 3b, 3c, of which only individual ones are designated in FIG. 1.

In this embodiment, the drive wheels 21, 22 are arranged coaxially with respect to one another. Furthermore, in this exemplary embodiment both the number of engagement elements and the tooth spacings of the first drive gear 21 are the same as those of the second drive gear 22. The drive gears 21, 22 are aligned tangentially, i.e., along the circumference, in such a way that the engagement elements 210a, 210b, 210c, . . . of the first drive gear 21 and the engagement elements 220a, 220b, 220c, . . . , of the second drive gear 22 sequentially and alternately (with respect to the two drive gears 21, 22) engage the engagement elements 3a, 3b, 3c, . . . of the mating toothing 3. This is achieved by a number of n first engagement elements 210a, 210b, 210c, . . . , 210g of the first drive wheel 21 being tangentially (i.e., in the circumferential direction or along the circumference) offset by an offset angle α relative to a number of n second engagement elements 220a, 220b, 220c, . . . , 220g of the second drive wheel 22. For example, α is approximately 360° /2N for two drive wheels 21, 22. With three drive wheels, the offset angle α a may, for example, be approx. 360°/3N, but is generally approx. 360°/(z*N), where z is the number of drive wheels in drive system 1. The number N may be adapted to the number z, approximately so that the value z*N for a design with z drive wheels corresponds to the value N for a corresponding design with a single drive wheel z=1.

Each of the drive wheels 21, 22 is driven independently of the other drive wheel 21 or 22 by an electric motor 41, 42 assigned to it, or the drive wheels are driven by a single motor transferring the torque via a differential gear.

The electric motors 41, 42 are electrically controlled in such a way that a larger tooth contact overlap is simulated for the two drive wheels 21, 22, which would otherwise only be achievable with a larger pitch circle diameter of a single drive wheel. Simulating a larger tooth contact overlap is achieved by controlling the torque of both drive motors 41, 42 so that a tooth of a drive wheel advances a tooth of the mating toothing with higher speed until there is tooth contact over which the torque may be applied. This kind of control results in that the (tangential) distance between the engagement elements 210a, 220a; 210b, 220b; . . . of the two drive wheels 21 and 22 will always vary slightly, i.e. the tangential offset of the drive wheels 21, 22 varies by an angle Δα (i.e. the offset of the engagement elements is α+/−Δα) and always adjusts itself so that at least one engagement element of each drive wheel 21, 22 is always engaged and may apply a rate of the total drive force/torque to the mating toothing 3. The faster forward rotation (until a tooth contacts a mating tooth) ensures that, despite a smaller pitch diameter, several engagement elements are simultaneously engaged with the mating toothing 3 in a given period of time.

The total driving force generated by a motor or several motors 41 and 42 may thus be reliably and evenly distributed among the two (or more) engagement elements (e.g. 210a, 220a). This means that the engagement elements 210, 220 and the mating-toothing 3 may be designed in smaller dimensions. In addition, redundancy is provided so that if one drivetrain 21, 41 fails, at least one other drivetrain 22, 42 will be available, which may still provide a rate of the total driving force.

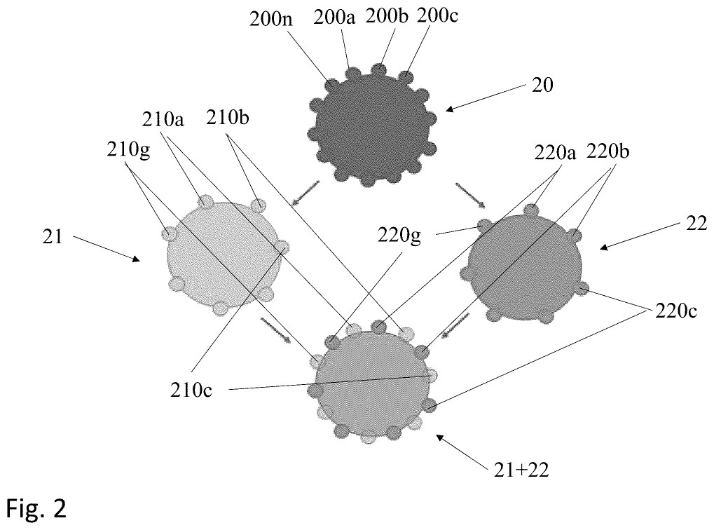

FIG. 2 shows the configuration of the drive wheels 21 and 22 in the case of two drive wheels 21 and 22 arranged in parallel and coaxially.

Starting from a configuration with a drive gear 20 with 2n=14 (N=7) engagement elements 200a, 200b, . . . 200n, the drive gear 20 is divided into two drive gears 21, 22. Each of these two drive gears 21, 22 has only half (N=7) of the original 2N=14 engagement elements, so that when these two drive wheels 21 and 22 are arranged laterally parallel and coaxially, all engagement elements 210a, 210b, . . . , 210g, 220a, 220b, . . . 220g correspond to the positions of the engaging elements 200a, 200b, . . . 200n of the original drive wheel 20, i.e. they are congruent with these in the lateral projection (see drive wheel combination 21+22 shown at the bottom of FIG. 2).

The two separate coaxially arranged drive wheels 21, 22 are controlled separately. The engagement elements 210, 220 of the drive wheels 21, 22, which are located one above the other, are arranged tangentially offset to one another by an angle of approx. 360°/2n=360°/14=approx. 26°, so that the engagement elements 210a, 220a; 210b, 220b; . . . , 210g, 220g of the different drive wheels 21 and 22 engage the mating-toothing 3 alternately.

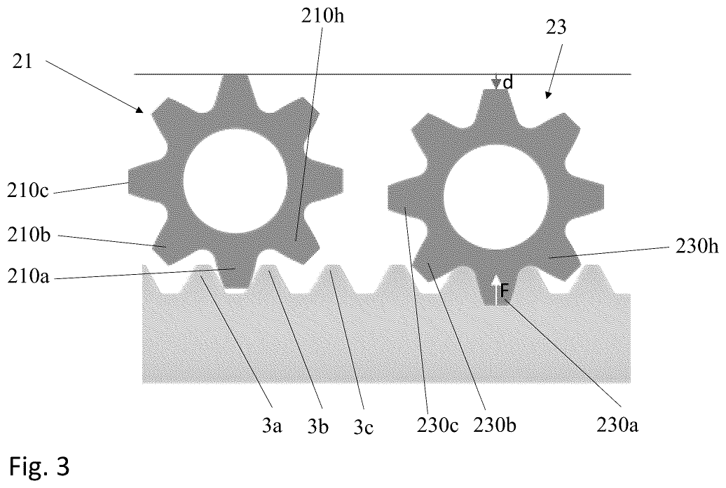

FIG. 3 shows a further aspect of the present disclosure, which may be realized independently of or in conjunction with the above-mentioned embodiments.

A conventional drive wheel 21, as shown on the left side of FIG. 3, or as described above, has engagement elements 210a, 210b, . . . , 210h. The drive wheel 21 is rigid (e.g., essentially rigid). For this reason, the distance between the drive gear 21 and the mating toothing 3 must be set relatively precisely and, if necessary, provided with a clearance so that no undesirable forces act on the gear head when it comes into contact with the mating toothing 3.

A modified drive wheel 23 is shown on the right side of FIG. 3. It has engagement elements (e.g. teeth or rollers) 230a, 230b, . . . , 230h, which are radially displaceably mounted in the drive wheel 23, so that the distance between the drive wheel 23 and the mating toothing may be reduced (e.g. by an amount d) and the pitch circle of the drive gear 23 may also be adjusted. This measure saves space. A spring holds the engagement elements in an outer position so that normal engagement is possible. When the engagement element of the drive wheel is in the tooth base of the mating toothing, the engagement element is then pressed radially against a counterforce F, for example a spring force. This allows deviations in the distance between the drive wheel 23 and the mating toothing 3 to be compensated.

The following enumerated paragraphs describe additional aspects and features of the drive systems and methods of the present disclosure.
A0. A drive system (1) comprising:
a drive element (2); and
a mating toothing (3), wherein
the drive element (2) has two or more drive wheels (21, 22), including a first drive wheel and a second drive wheel, each of them having engagement elements (210, 220), the engagement elements (210) of the first drive wheel (21) being offset tangentially relative to the engagement elements (220) of the second drive wheel (22), so that engagement elements (210, 220) of the drive wheels (21, 22) engage the mating toothing (3) alternately, and at least one engagement element (210) of the first drive wheel (21) and at least one engagement element (220) of the second drive wheel (22) is in engagement with the mating toothing (3) at least temporarily.
A1. The drive system (1) according to A0, wherein the drive system (1) has a common motor for at least two of the drive wheels (21, 22), which drives the at least two drive wheels (21, 22) via a mechanical and/or hydraulic torque distribution.
A2. The drive system according to A1, wherein the mechanical and/or hydraulic torque distribution comprises at least one differential gear.
A3. The drive system (1) according to any one of paragraphs A0 through A2, wherein the drive system (1) has at least two motors (41, 42) which each drive at least one of the drive wheels (21, 22).
A4. The drive system (1) according to any one of paragraphs A0 through A3, wherein the drive system (1) has at least two motors (41, 42) which are controlled in such a way that they apply a constant torque at least for a period of the time.
A5. The drive system (1) according to A4, wherein the at least two motors (41, 42) are electric motors with a torque control or a torque regulation.
A6. The drive system (1) according to any one of paragraphs A0 through A5, wherein the at least two drive wheels (21, 22) are arranged axially offset relative to each other.
A7. The drive system (1) according to any one of paragraphs A0 through A5, wherein the at least two drive wheels (21, 22) are arranged coaxially offset relative to one another.
A8. The drive system (1) according to any one of paragraphs A0 through A5, wherein the at least two drive wheels (21, 22) are arranged radially offset relative to each other.
A9. The drive system (1) according to any one of paragraphs A0 through A8, wherein the drive wheels (21, 22) are arranged at a vehicle and the counter toothing (3) is arranged in a stationary manner at a transport track.
A10. The drive system (1) according to any one of paragraphs A0 through A9, wherein the mating toothing (3) comprises at least one rack.
A11. The drive system (1) according to any one of paragraphs A0 through A10, wherein the engagement elements (210, 220) are designed as cylinders, each having at least one rotatable element for rolling the cylinders on the mating toothing (3).
A12. The drive system (1) according to any one of paragraphs A0 through A11, wherein at least one of the drive wheels (23) has engagement elements (230) that are arranged so as to be radially displaceable in relation to the center of the drive wheel (23).
A13. The drive system (1) according to A12, wherein the engagement elements (230) are pushed radially outwards from the center of the drive wheel (23) by an elastic force (F).
B0. A drive system comprising:
a drive element; and
a mating toothing; wherein
the drive element includes a first drive wheel and a second drive wheel, each having respective engagement elements, the engagement elements of the first drive wheel being offset tangentially relative to the engagement elements of the second drive wheel, such that the engagement elements of the drive wheels engage the mating toothing alternately, and at least one of the engagement elements of the first drive wheel and at least one of the engagement elements of the second drive wheel are in engagement with the mating toothing at least temporarily.
B1. The drive system according to B0, wherein the first and second drive wheels have a common motor configured to drive the drive wheels via a mechanical and/or hydraulic torque distribution.
B2. The drive system according to B1, wherein the mechanical and/or hydraulic torque distribution comprises at least one differential gear.
B3. The drive system according to any one of paragraphs B0 through B2, wherein the drive system comprises two motors which each drive at least one of the drive wheels.
B4. The drive system according to any one of paragraphs B0 through B4, wherein the drive system comprises at least two motors operatively coupled to the drive wheels, and the drive system is configured to control the at least two motors to apply a constant torque at least for a period of the time.
B5. The drive system according to B4, wherein the at least two motors are electric motors having a torque control or a torque regulation.
B6. The drive system according to any one of paragraphs B0 through B5, wherein the first and second drive wheels are arranged axially offset relative to each other.
B7. The drive system according to any one of paragraphs B0 through B5, wherein the first and second drive wheels are arranged coaxially offset relative to one another.
B8. The drive system according to any one of paragraphs B0 through B5, wherein the first and second drive wheels are arranged radially offset relative to each other.
B9. The drive system according to any one of paragraphs B0 through B8, wherein the first and second drive wheels are coupled to a vehicle and the mating toothing is coupled in a stationary manner to a transport track.
B10. The drive system according to any one of paragraphs B0 through B9, wherein the mating toothing comprises at least one rack.
B11. The drive system according to any one of paragraphs B0 through B10, wherein the engagement elements are cylinders, each having at least one rotatable element configured to roll the cylinders on the mating toothing.
B12. The drive system according to any one of paragraphs B0 through B11, wherein at least one of the drive wheels has engagement elements arranged such that the engagement elements are configured to be radially displaceable in relation to a center of the drive wheel.
B13. The drive system according to B12, wherein the engagement elements are configured to be pushed radially outward from a center of the drive wheel by an elastic force.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A drive system comprising:
a drive element; and
a mating toothing; wherein
the drive element includes a first drive wheel and a second drive wheel, each having respective engagement elements, the engagement elements of the first drive wheel being offset tangentially relative to the engagement elements of the second drive wheel, such that the engagement elements of the drive wheels engage the mating toothing alternately, and at least one of the engagement elements of the first drive wheel and at least one of the engagement elements of the second drive wheel are in engagement with the mating toothing at least temporarily.

2. The drive system according to claim 1, wherein the first and second drive wheels have a common motor configured to drive the drive wheels via a mechanical and/or hydraulic torque distribution.

3. The drive system according to claim 2, wherein the mechanical and/or hydraulic torque distribution comprises at least one differential gear.

4. The drive system according to claim 1, wherein the drive system comprises two motors which each drive at least one of the drive wheels.

5. The drive system according to claim 1, wherein the drive system comprises at least two motors operatively coupled to the drive wheels, and the drive system is configured to control the at least two motors to apply a constant torque at least for a period of the time.

6. The drive system according to claim 5, wherein the at least two motors are electric motors having a torque control or a torque regulation.

7. The drive system according to claim 1, wherein the first and second drive wheels are arranged axially offset relative to each other.

8. The drive system according to claim 1, wherein the first and second drive wheels are arranged coaxially offset relative to one another.

9. The drive system according to claim 1, wherein the first and second drive wheels are arranged radially offset relative to each other.

10. The drive system according to claim 1, wherein the first and second drive wheels are coupled to a vehicle and the mating toothing is coupled in a stationary manner to a transport track.

11. The drive system according to claim 1, wherein the mating toothing comprises at least one rack.

12. The drive system according to claim 1, wherein the engagement elements are cylinders, each having at least one rotatable element configured to roll the cylinders on the mating toothing.

13. The drive system according to claim 1, wherein at least one of the drive wheels has engagement elements arranged such that the engagement elements are configured to be radially displaceable in relation to a center of the drive wheel.

14. The drive system according to claim 13, wherein the engagement elements are configured to be pushed radially outward from a center of the drive wheel by an elastic force.
